(19) United States
(12) Patent Application Publication
(10) Pub. No.: US 2026/0160234 A1
(43) Pub. Date: Jun. 11, 2026

(54) MULTI-VIEW FUSION METHOD FOR FORECASTING POWER OF WIND TURBINES IN OFFSHORE WIND FARM

(71) Applicant: GUANGDONG UNIVERSITY OF TECHNOLOGY, Guangdong (CN)

(72) Inventors: Anbo MENG, Guangdong (CN); Jianbin ZHU, Guangdong (CN); Hanhong LI, Guangdong (CN); Yiding YIN, Guangdong (CN)

(73) Assignee: GUANGDONG UNIVERSITY OF TECHNOLOGY, Guangdong (CN)

(21) Appl. No.: 19/073,023

(22) Filed: Mar. 7, 2025

(30) Foreign Application Priority Data
Mar. 13, 2024 (CN) 202410283505.7

(51) Int. Cl. F03D 17/00

(52) U.S. Cl. CPC F03D 17/006; F03D 17/026; F05B 2200/00; F05B 2200/12; F05B 2200/13; F05B 2200/14; F05B 2200/211; F05B 2200/221; F05B 2240/95; F05B 2260/821; F05B 2270/32; F05B 2270/321; F05B 2270/335

(57) ABSTRACT

Provided is a multi-view fusion method for forecasting power of wind turbine group in an offshore wind farm including obtaining a feature vector, constructing a power relationship matrix and a graph matrix based on data of wind turbine group and a geographical position of each wind turbine, constructing a spatial graph embedding module, to embed the graph matrix into node spatial information and inter-graph node information, inputting an embedding information matrix to a cross-fusion convolution module, constructing a Chebyshev graph convolutional neural network to process the feature vector and a multi-view topology matrix, to enable the feature vector of each wind turbine to obtain effective weights of other wind turbine group, and finally screening, by a multi-timing gating module, a time sequence feature. In the method, structural features of the wind turbine group can be fully captured, and dynamic features of the wind turbine group can be fully captured.

### CROSS-REFERENCE TO RELATED APPLICATION

This application claims the priority benefit of China application serial no. 202410283505.7, filed on Mar. 13, 2024. The entirety of the above-mentioned patent application is hereby incorporated by reference herein and made a part of this specification.

### TECHNICAL FIELD

The present invention relates to the technical field of wind power forecast, and in particularly, to a multi-view fusion method for forecasting power of wind turbines in an offshore wind farm.

### BACKGROUND

With the rapid development of offshore wind power, accurately forecasting the power of wind turbines has become an important problem. Accurate forecasting can help the power grid dispatching departments to better manage the power system and ensure that the power system operates safely and stably. However, power forecasting for offshore wind turbines faces many challenges. First, the dynamic features of offshore wind turbines, complex topology structures, and the relationship between the wind turbines all affect the forecast accuracy. In addition, due to particularity of a geographical position and meteorological conditions of an offshore wind farm, the conventional forecasting methods do not meet forecasting needs.

The prior art discloses a prediction method based on deep learning. This method includes the following steps: establishing a spatiotemporal correlation of a hybrid neural network for performing short-term power forecast, and accumulating short-term power forecast results of all spatiotemporal correlation sub-clusters, to obtain a short-term power forecast result of regional wind power in a to-be-forecast period. However, the above method cannot fully capture the structural features of the wind turbines when processing the complex topology structure of the wind turbines. In addition, because the hybrid neural network cannot fully capture the dynamic features of the wind turbines, accurate and reliable forecast results cannot be obtained.

### SUMMARY

An objective of the present invention is to overcome the deficiencies in the prior art, and to provide a multi-view fusion method for forecasting power of wind turbine group in an offshore wind farm, to fully capture structural features of wind turbine group, and fully capture dynamic features of the wind turbine group, thereby effectively improving forecast accuracy of offshore wind power.

To resolve the above technical problems, the technical solution adopted by the present invention is:

A multi-view fusion method for forecasting power of wind turbine group in an offshore wind farm is provided, and includes the following steps:
S1, obtaining power, a wind speed, a wind direction, and precipitation data of each wind turbine in a target offshore wind farm, and a geographical position of wind turbine, and performing preprocessing;
S2, constructing a feature matrix with preprocessed power, wind speed, wind direction, and precipitation data in the wind farm, constructing a power relationship matrix and a Euclidean distance matrix based on the power of the wind turbines in the wind farm after the preprocessing, and constructing a geographical position matrix and a neighbor relationship matrix based on the geographical position of each wind turbine;
S3, constructing a spatial graph embedding module and a cross-fusion convolution module, sequentially inputting a plurality of graph matrices to the spatial graph embedding module and the cross-fusion convolution module, performing spatial correlation embedding and inter-graph correlation embedding in the spatial graph embedding module, and performing attention extraction and fusion on the cross-fusion convolution module, where the graph matrix includes a power relationship matrix, a geographical position matrix, a neighbor relationship matrix, and a Euclidean distance matrix;
S4, constructing a graph convolutional neural network that considers influence of spatial topology, and inputting a processed feature matrix together with a multi-view topology matrix to the graph convolutional neural network, to obtain a feature matrix that fuses a plurality of pieces of topological information;
S5, constructing a multi-timing gating module, making the feature matrix that fuses the information pass through the multi-timing gating module to implement receptive fields at different times, and finally obtaining a forecast output of spatiotemporal information aggregation; and
S6, training a model with a training set, to obtain an optimal model parameter, and inputting a wind power state feature at a next time point to an optimal model obtained through training, to forecast wind power at the next time point.

In the multi-view fusion method for forecasting power of wind turbine group in an offshore wind farm provided in the present present invention, a wind speed time sequence, a wind direction time sequence, and a wind power time sequence are preprocessed, to obtain a feature vector; the power relationship matrix, the geographical position matrix, the neighbor relationship matrix, and the Euclidean distance matrix are constructed based on the data and the geographical position of each wind turbine; the spatial graph embedding module is constructed, to embed the graph matrix into node spatial information and inter-graph node information, and then the embedding information matrix is input to the cross-fusion convolution module; key spatial information and key inter-graph information are further concerned and extracted, to obtain the multi-view topology matrix, thereby providing an effective weight relationship between the wind turbines for the subsequent graph convolutional neural network; a Chebyshev graph convolutional neural network is constructed to process the feature vector and the multi-view topology matrix, to enable the feature vector of each wind turbine to obtain effective weights of other wind turbines; and finally, the multi-timing gating module screens a time sequence feature. In the multi-view fusion method for forecasting power of wind turbine group in an offshore wind farm provided in the present invention, the structural features of the wind turbine group can be fully captured, and the dynamic features of the wind turbine group can be fully captured. This effectively reduces an error caused by ignoring the relationship between the wind turbines, makes up for the lack of data features of a single wind turbine, and improves overall forecast accuracy of offshore wind power.

Preferably, in step S1, min-max normalization processing is performed on a power sequence, a wind speed sequence, and a precipitation sequence, to obtain a power sequence P, a wind speed sequence WS, and a precipitation sequence PRECIP after the normalization processing, and sine and cosine processing is performed on a wind direction sequence, to obtain a sine of wind direction SWD and a cosine of wind direction CWD.

Preferably, step S2 includes the following steps:
S21, performing preprocessing to obtain a feature matrix X of m wind turbines, where X=[X₁, X₂, . . . , Xₘ], Xₘ represents a matrix constructed with features of an m^{th} wind turbine from a time point t−1 to a time point t−n, and Xₘ is expressed as follows:

$${X}_{m} = [ \begin{matrix}{P}_{m}^{t - 1} & {WS}_{m}^{t - 1} & {SWD}_{m}^{t - 1} & {CWD}_{m}^{t - 1} & {PRECIP}_{m}^{t - 1} \\ {P}_{m}^{t - 2} & {WS}_{m}^{t - 2} & {SWD}_{m}^{t - 2} & {CWD}_{m}^{t - 2} & {PRECIP}_{m}^{t - 2} \\ … & … & … & … & … \\ {P}_{m}^{t - n} & {WS}_{m}^{t - n} & {SWD}_{m}^{t - n} & {CWD}_{m}^{t - n} & {PRECIP}_{m}^{t - n}\end{matrix} ]$$

$$where \begin{matrix}{P}_{m}^{t - n} , & {WS}_{m}^{t - n} , & {SWD}_{m}^{t - n} , & {CWD}_{m}^{t - n} , and & {PRECIP}_{m}^{t - n}\end{matrix}$$

respectively represent power, a wind speed, a wind direction sine, a wind direction cosine, and precipitation of an m^{th} wind farm at a time point t−n;
S22, constructing the plurality of information matrices based on different perspectives, where the information matrix includes a power relationship matrix W^{P}, a geographical position matrix W^{D}, a neighbor relationship matrix W^{N}, and a Euclidean distance matrix W^{E};
calculating, by the power relationship matrix W^{P}, a Pearson correlation coefficient of power data between the wind turbines, to obtain a correlation coefficient Rᵢⱼ between every two wind turbines, and mapping the correlation coefficient Rᵢⱼ into an interval of [−1, 1] through a sigmoid function, where a specific expression is as follows:

$$\begin{matrix}R = \frac{{\sum }_{k = 1}^{n} ( {a}_{k} - \overline{a} ) ( {b}_{k} - \overline{b} )}{\sqrt{{\sum }_{k = 1}^{n} {( {a}_{k} - \overline{a} )}^{2} {\sum }_{k = 1}^{n} {( {b}_{k} - \overline{b} )}^{2}}} \\ {W}_{ij}^{P} : = \{ \begin{matrix}sigmoid ( {R}_{ij} ) , & wherein i \neq j , \\ 1 , & other conditions .\end{matrix}\end{matrix}$$

where R represents the Pearson correlation coefficient, n represents a dimension of a variable, a and b respectively represent power of two wind turbines, aₖ and bₖ respectively represent k^{th} data points of the power of the two wind turbines, ā and b̅ respectively represent a mean value of the power of the two wind turbines, k∈[1, n],

$${W}_{ij}^{P}$$

represents an element of an i^{th} row and a j^{th} column of the power relationship matrix W^{P}, and Rᵢⱼ represents a Pearson correlation coefficient between an i^{th} wind turbine and a j^{th} wind turbine;
calculating, by the geographical position matrix W^{D}, a distance dᵢⱼ between the wind turbines based on a collected coordinate position of each wind turbine, and obtaining a distance-mapped weight through a Gaussian kernel function, where a specific expression is as follows:

$${W}_{ij}^{D} : = \{ \begin{matrix}exp ( - \frac{{d}_{ij}^{2}}{{σ}_{D}^{2}} ) , & wherein i \neq j and exp ( - \frac{{d}_{ij}^{2}}{{σ}_{D}^{2}} ) \geq ε , \\ 0 , & other conditions .\end{matrix}$$

where σ_{D} represents a standard deviation parameter of the Gaussian kernel function, E represents a threshold, and

$${W}_{ij}^{D}$$

represents an element of an i^{th} row and a j^{th} column of the geographical position matrix W^{D};
determining, by the neighbor relationship matrix W^{N}, whether the wind turbines are adjacent, and a specific expression is as follows:

$${W}_{i j}^{N} : = \{ \begin{matrix}1 , & if an ith wind turbine and a jth wind turbine are adjacent , \\ 0 , & other conditions .\end{matrix}$$

$$where {W}_{ij}^{N}$$

represents an element of an i^{th} row and a j^{th} column of the neighbor relationship matrix W^{N}; and
representing, by the Euclidean distance matrix W^{E}, an approximate distribution of the power data through a histogram, and then fitting a trend of the histogram through a function ƒ(x)=αe^{-βx}, to obtain values of α and β of ƒ(x)=αe^{-βx} corresponding to each histogram, calculating a Euclidean distance

$${d}_{i j}^{E}$$

of each wind turbine by applying a Euclidean distance formula, and obtaining a Euclidean distance-mapped weight through the Gaussian kernel function, where a specific expression is as follows:

$$\begin{matrix}{d}_{i j}^{E} = \sqrt{{( {α}_{i} - {α}_{j} )}^{2} + {( {β}_{i} - {β}_{j} )}^{2}} \\ {W}_{ij}^{E} : = \{ \begin{matrix}exp ( - \frac{{‖ {d}_{ij}^{E} ‖}^{2}}{{σ}_{E}^{2}} ) , & wherein i \neq j \\ 0 , & other conditions .\end{matrix}\end{matrix}$$

where αᵢ, αⱼ, βᵢ, βⱼ respectively represent parameters of a fitting function ƒ(x)=αe^{-βx} corresponding to power histograms of the i^{th} wind turbine and the j^{th} wind turbine, σ_{E} represents a standard deviation parameter of the Gaussian kernel function, and

$${W}_{ij}^{E}$$

represents an element of an i^{th} row and a j^{th} column of the Euclidean distance matrix W^{E}.

Preferably, in step S3, the performing spatial correlation embedding and inter-graph correlation embedding in the spatial graph embedding module includes the following steps:
S31, combining the plurality of graph matrices into a multi-graph matrix block W^{M} in a stacking manner, performing spatial embedding on the geographical position matrix W^{D}, capturing, by a Node2Vec model, a spatial structure relationship between wind turbine nodes by learning similarity between the nodes, and representing the node as a dense vector SE;
S32, performing graph embedding on one node of each graph of W^{M}, and encoding a selected node via OneHot, to obtain a vector assignment GE between graphs; and
S33, adding SE and GE together, to obtain an embedding matrix W^{SGE} that includes spatial information and inter-graph information.

Preferably, in step S3, the cross-fusion convolution module includes two convolution attention modules and a gated fusion unit, each of two convolution attention layers is connected with one fully connected layer, an activation function of the gated fusion unit is the sigmoid function, one fully connected layer is connected to the gated fusion unit, an activation function of the fully connected layer is a ReLU function, and the two convolution attention modules are a channel attention module and a spatial attention module respectively.

Preferably, the performing attention extraction and fusion on the cross-fusion convolution module includes the following steps:
S34, inputting the embedding matrix W^{SGE} obtained in step S33 to the two convolution attention modules;
S35, performing dimension conversion on the embedding matrix W^{SGE} such that the embedding matrix subjected to dimension conversion is appropriately put into the cross-fusion convolution, to obtain a spatial embedding matrix

$${W}_{spatial}^{SGE}$$

and a graph embedding matrix

$${W}_{graph}^{SGE} ,$$

respectively inputting the spatial embedding matrix

$${W}_{spatial}^{SGE}$$

and the spatial embedding matrix

$${W}_{graph}^{SGE}$$

to the cross-fusion convolution, and sequentially entering the channel attention module and the spatial attention module in the cross-fusion convolution

$$\{ \begin{matrix}{M}_{CA} ( W ) = sigmoid ( MLP ( AvgPool ( W ) ) + MLP ( Max Pool ( W ) ) ) \\ {M}_{SA} ( W ) = sigmoid ( Conv ( [ AvgPool ( W ) ; Max Pool ( W ) ] ) )\end{matrix}$$

$$\{ \begin{matrix}{W}_{spatial}^{′} = {M}_{CA} ( {W}_{spatial}^{SGE} ) ⊗ {W}_{spatial}^{SGE} \\ {W}_{spatial}^{″} = {M}_{SA} ( {W}_{spatial}^{′} ) ⊗ {W}_{spatial}^{′} \\ {W}_{graph}^{′} = {M}_{CA} ( {W}_{graph}^{SGE} ) ⊗ {W}_{graph}^{SGE} \\ {W}_{graph}^{″} = {M}_{SA} ( {W}_{graph}^{′} ) ⊗ {W}_{graph}^{′}\end{matrix}$$

where W represents an input embedding matrix, AvgPool and MaxPool represent an average pooling operation and a maximum pooling operation respectively, MLP represents the two fully connected layers, Conv represents a 2D convolution layer, M_{CA} represents channel attention processing, M_{SA} represents spatial attention processing, ⊗ represents matrix multiplication,

$${W}_{spatial}^{′}$$

represents an intermediate result obtained by performing channel processing on

$${W}_{spatial}^{SGE} , {W}_{graph}^{′}$$

represents an intermediate result obtained by performing channel processing on

$${W}_{graph}^{SGE} , {W}_{spatial}^{″}$$

represents a spatial attention matrix, and

$${W}_{graph}^{″}$$

represents a graph attention matrix; and
S36, inputting, to the gated fusion unit, a spatial attention matrix

$${W}_{spatial}^{″}$$

and a graph attention matrix

$${W}_{graph}^{″}$$

subjected to attention convolution processing, to obtain a multi-view topology matrix A_{SG},

$$\{ \begin{matrix}z = σ ( FC ( {W}_{spatial}^{″} ) {W}_{1} + FC ( {W}_{graph}^{″} ) {W}_{2} + b ) \\ {A}_{SG} = z ⊙ FC ( {W}_{spatial}^{″} ) + ( 1 - z ) ⊙ FC ( {W}_{graph}^{″} )\end{matrix}$$

where FC represents the fully connected layer, W₁, W₂, and b represent three parameters capable of being used for gradient training, z represents weight coefficients of the spatial attention matrix and the graph attention matrix, ⊙ represents a Hadamard product, and σ represents a sigmoid function.

Preferably, in step S4, domain information, of a feature sequence X=[X₁, X₂, . . . , Xₘ] of the m wind turbines, extracted between spatial nodes via a graph convolution kernel g_{θ}, and the multi-view topology matrix A_{SG} are input to the graph convolutional neural network, to extract domain information X′=[X′₁, X′₂, . . . , X′ₘ] between the spatial nodes through a graph convolution kernel function g_{θ}.

Preferably, in step S4, calculation steps of a graph convolution formula in the graph convolutional neural network are as follows:
S41, setting a preliminary graph convolution formula of the graph convolutional neural network as follows:

$${g}_{θ} {*}_{G} x = {g}_{θ} ( L ) x = {g}_{θ} ( U Λ {U}^{T} ) x = {Ug}_{θ} ( Λ ) {U}^{T} x$$

where x represents input data, g_{θ} represents the graph convolution kernel function, *G represents a graph convolution operation, L=D−A_{SG} represents a Laplacian matrix of the graph, with a normalization form and a decomposition form of a feature value being

$$L = {I}_{N} - {D}^{- \frac{1}{2}} {A}_{𝒮 G} {D}^{- \frac{1}{2}} ∈ {R}^{N \times N}$$

and L=UΛU^{T}∈R^{N×N} respectively, Λ=diag(λ₀, . . . , λ_{N-1})∈R^{N×N} represents a diagonal matrix, U represents a feature vector obtained after normalization is performed on a Laplacian matrix L, A_{SG}∈R^{N×N} represents the multi-view topology matrix, I_{N}∈R^{N×N} represents a unit matrix, and a degree matrix D∈R^{N×N} is a diagonal matrix constituted with node degrees Dᵢᵢ=ΣⱼAᵢⱼ;
S42, approximately replacing a spectral domain convolution kernel with a Chebyshev polynomia, where the Chebyshev polynomia is defined as:

$${g}_{θ} ( Λ ) = {\sum }_{k = 0}^{K - 1} {θ}_{k} {T}_{k} ( \hat{Λ} )$$

where K represents a total quantity of terms of the Chebyshev polynomia, θₖ represents a coefficient vector of a k^{th} term of the Chebyshev polynomia, and a Chebyshev polynomia that is calculated recursively is defined as follows:

$${T}_{k} ( x ) = 2 x {T}_{k - 1} ( x ) - {T}_{k - 2} ( x )$$

where T₀(x)=1, T₁(x)=x, information of 0^{th} to (K−1)^{th} order neighbors around each node in the graph is extracted through approximate expansion of the Chebyshev polynomia, and because a definition domain of Tₖ(x)=cos(k·arccos(x)) is as [−1,1], that is, a value domain of \tilde{Λ} is [−1, 1], the following is obtained after standardization of a feature vector matrix Λ:

$$\tilde{Λ} = \frac{2}{{λ}_{max}} Λ - {I}_{N}$$

where λₘₐₓ represents a maximum value of a feature value of the Laplacian matrix; and
S43, replacing a convolution kernel with Tₖ(\tilde{Λ}), to obtain a final graph convolution formula as follows:

$$\begin{matrix}{g}_{θ} {*}_{G} x = {Ug}_{θ} ( Λ ) {U}^{T} x = U ( {\sum }_{k = 0}^{K - 1} {θ}_{k} {T}_{k} ( \tilde{Λ} ) ) {U}^{T} x \\ = {\sum }_{k = 0}^{K - 1} {θ}_{k} {T}_{k} ( U \tilde{Λ} {U}^{T} ) x \\ = {\sum }_{k = 0}^{K - 1} {θ}_{k} {T}_{k} ( \tilde{L} ) x\end{matrix}$$

where \tilde{L}=U\tilde{Λ}U^{T}.

Preferably, in step S5, the multi-timing gating module implements different receptive fields via different sizes of convolution kernels, and

$${X}^{′} = [ {X}_{1}^{′} , {X}_{2}^{′} , … , {X}_{m}^{′} ]$$

is input and processed via 1×S convolution kernels Γ∈R_{1×S×C×2C}, where S represents a size of the convolution kernel, C represents a quantity of channels, finally output power

$${Y}_{pred} = [ {Y}_{1}^{pred} , {Y}_{2}^{pred} , … , {Y}_{m}^{pred} ]$$

of each wind turbine is obtained, and a formula is as follows:

$$\{ \begin{matrix}{X}^{\text{?}} = Γ * {X}^{′} ∈ {R}^{N \times ( M - ( S - 1 ) ) \times 2 C} \\ {Γ}_{i} {*}_{τ} {X}^{′} = tanh ( {X}_{st}^{\text{?}} ) ⊙ sigmoid ( {X}_{rd}^{\text{?}} ) ∈ {R}^{N \times ( M - ( S - 1 ) ) \times 2 C}\end{matrix}$$

$$\text{?} \text{indicates text missing or illegible when filed}$$

where *_{τ} represents a gated convolution operator,

$${X}_{st}^{″} and {X}_{rd}^{″}$$

respectively represent a first half and a second half of X″ with a doubled quantity of channels, Γᵢ represents an i^{th} convolution kernel; and a formula for calculating the output power of each wind turbine by superimposing GTU into M-GTU is as follows:

$${Y}_{pred} = ReLU ( Pooling ( Concat ( ( {Γ}_{1} {*}_{τ} {X}^{′} ) , ( {Γ}_{2} {*}_{τ} {X}^{′} ) , ( {Γ}_{3} {*}_{τ} {X}^{′} ) ) ) + {X}^{′} )$$

where Γ₁, Γ₂, and Γ₃ represent the different sizes of the convolution kernels, that is, 1×S₁, 1×S₂, and 1×S₃ respectively, Pooling represents a pooling layer, Concat represents a splicing operation, and X′ is obtained by splicing three different sizes of GTUs.

Compared with the prior art, the present invention has the following beneficial effects:

In the multi-view fusion method for forecasting power of wind turbine group in an offshore wind farm provided in the present invention, the structural features of the wind turbine group can be fully captured, and the dynamic features of the wind turbine group can be fully captured. This effectively reduces an error caused by ignoring the relationship between the wind turbines, makes up for the lack of data features of a single wind turbine, and improves overall forecast accuracy of offshore wind power.

### BRIEF DESCRIPTION OF DRAWINGS

FIG. 1 is a flowchart of a multi-view fusion method for forecasting power of wind turbine group in an offshore wind farm according to the present invention;

FIG. 2 is a schematic diagram of a spatial relationship between a wind turbine and another wind turbine in each graph matrix that is implemented through spatial attention;

FIG. 3 is a schematic diagram of an inter-graph relationship between wind turbines in each graph matrix that is implemented through graph attention;

FIG. 4 is a schematic diagram of forecast effect of a multi-view fusion method for forecasting power of wind turbine group in an offshore wind farm in an embodiment 2; and

FIG. 5 is a schematic diagram of a multi-view fusion system for forecasting power of wind turbine group in an offshore wind farm according to the present invention.

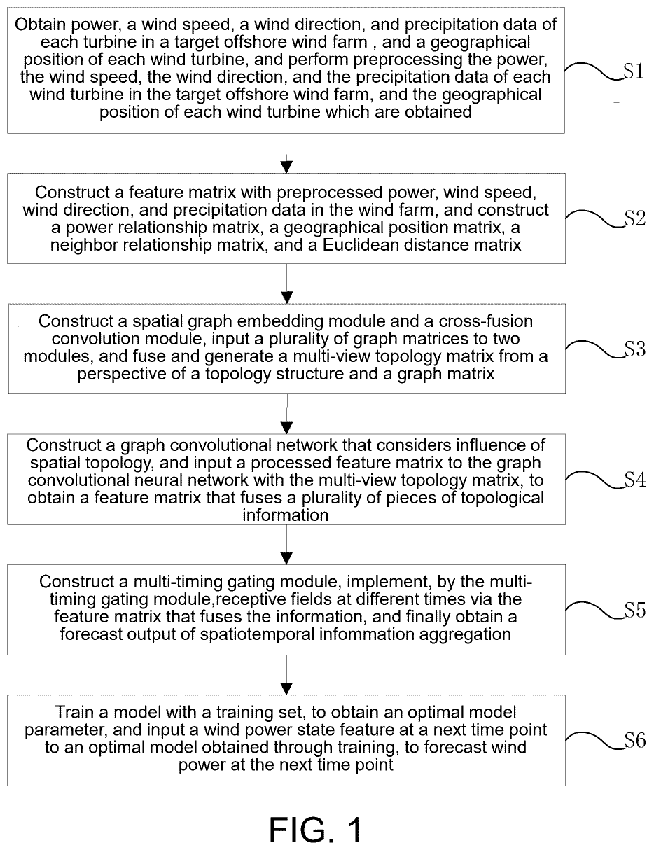

### DETAILED DESCRIPTION OF EMBODIMENTS

The present invention will be further described below with reference specific implementations.

### Embodiment 1

This embodiment is an embodiment of a multi-view fusion method for forecasting power of wind turbine group in an offshore wind farm. The method includes the following steps.
S1: Obtain power, a wind speed, a wind direction, and precipitation data of each wind turbines in a target offshore wind farm, and a geographical position of each wind turbines, and perform preprocessing.
S2: Construct a feature matrix with preprocessed power, wind speed, wind direction, and precipitation data in the wind farm, construct a power relationship matrix and a Euclidean distance matrix based on the power of each wind turbine in the wind farm after the preprocessing, and construct a geographical position matrix and a neighbor relationship matrix based on the geographical position of each wind turbine.
S3: Construct a spatial graph embedding module and a cross-fusion convolution module, sequentially input a plurality of graph matrices to the spatial graph embedding module and the cross-fusion convolution module, perform spatial correlation embedding and inter-graph correlation embedding in the spatial graph embedding module, and perform attention extraction and fusion on the cross-fusion convolution module, where the graph matrix includes a power relationship matrix, a geographical position matrix, a neighbor relationship matrix, and a Euclidean distance matrix.
S4: Construct a graph convolutional neural network that considers influence of spatial topology, and input a processed feature matrix together with a multi-view topology matrix to the graph convolutional neural network, to obtain a feature matrix that fuses a plurality of pieces of topological information.
S5: Construct a multi-timing gating module, making the feature matrix that fuses the information pass through the multi-timing gating module to implement receptive fields at different times via the feature matrix that fuses the information, and finally obtain a forecast output of spatiotemporal information aggregation.
S6: Train a model with a training set, to obtain an optimal model parameter, and input a wind power state feature at a next time point to an optimal model obtained through training, to forecast wind power at the next time point.

In step S1, min-max normalization processing is performed on a power sequence, a wind speed sequence, and a precipitation sequence, to obtain a power sequence P, a wind speed sequence WS, and a precipitation sequence PRECIP after the normalization processing, and sine and cosine processing is performed on a wind direction sequence, to obtain a sine of wind direction SWD and a cosine of wind direction CWD. In the present invention, data processing can be performed on the power sequence, the wind speed sequence, and the precipitation sequence in other preprocessing manners such as mean value processing and difference value processing.

Step S2 includes the following steps.
S21: Perform preprocessing to obtain a feature matrix X of m wind turbines, where X=[X₁, X₂, . . . , Xₘ], Xₘ represents a matrix constructed with features of an m^{th} wind turbine from a time point t−1 to a time point t−n, and Xₘ is expressed as follows:

$${X}_{m} = [ \begin{matrix}{P}_{m}^{t - 1} & {WS}_{m}^{t - 1} & {SWD}_{m}^{t - 1} & {CWD}_{m}^{t - 1} & PRECI {P}_{m}^{t - 1} \\ {P}_{m}^{t - 2} & {WS}_{m}^{t - 2} & {SWD}_{m}^{t - 2} & {CWD}_{m}^{t - 2} & PRECI {P}_{m}^{t - 2} \\ … & … & … & … & … \\ {P}_{m}^{t - n} & {WS}_{m}^{t - n} & {SWD}_{m}^{t - n} & {CWD}_{m}^{t - n} & {PRCIP}_{m}^{t - n}\end{matrix} ]$$

$$where {P}_{m}^{t - n} , {WS}_{m}^{t - n} , {SWD}_{m}^{t - n} , {CWD}_{m}^{t - n} , and {PRCIP}_{m}^{t - n}$$

respectively represent power, a wind speed, a wind direction sine, a wind direction cosine, and precipitation of an m^{th} wind farm at a time point t−n;
S22: Construct the plurality of information matrices based on different perspectives, where the information matrix includes a power relationship matrix W^{P}, a geographical position matrix W^{D}, a neighbor relationship matrix W^{N}, and a Euclidean distance matrix W^{E}.

The power relationship matrix W^{P} calculates a Pearson correlation coefficient between power data of the wind turbines, to obtain a correlation coefficient Rᵢⱼ between every two wind turbines, and mapping the correlation coefficient Rᵢⱼ into an interval of [−1, 1] through a sigmoid function, where a specific expression is as follows:

$$R = \frac{{\sum }_{k = 1}^{n} ( {a}_{k} - \overline{a} ) ( {b}_{k} - \overline{b} )}{\sqrt{{\sum }_{k = 1}^{n} {( {a}_{k} - \overline{a} )}^{2} {\sum }_{k = 1}^{n} {( {b}_{k} - \overline{b} )}^{2}}}$$

$${W}_{ij}^{P} := \{ \begin{matrix}sigmoid ( {R}_{ij} ) , & wherein i \neq j , \\ 1 , & other conditions .\end{matrix}$$

where R represents the Pearson correlation coefficient, n represents a dimension of a variable, a and b respectively represent power of two wind turbines, aₖ and bₖ respectively represent k^{th} data points of the power of the two wind turbines, ā and b̅ respectively represent a mean value of the power of the two wind turbines, k∈[1, n],

$${W}_{ij}^{P}$$

represents an element of an i^{th} row and a j^{th} column of the power relationship matrix W^{P}, and Rᵢⱼ represents a Pearson correlation coefficient between an i^{th} wind turbine and a j^{th} wind turbine;
collecting, by the geographical position matrix W^{D}, a distance dᵢⱼ between the wind turbines based on a collected coordinate position of each wind turbine, and obtaining a distance-mapped weight through a Gaussian kernel function, where a specific expression is as follows:

$${W}_{ij}^{D} := \{ \begin{matrix}exp ( - \frac{{d}_{ij}^{2}}{{σ}_{D}^{2}} ) , & wherein i \neq j and exp ( - \frac{{d}_{ij}^{2}}{{σ}_{D}^{2}} ) \geq ε , \\ 0 , & other conditions .\end{matrix}$$

where σ_{D} represents a standard deviation parameter of the Gaussian kernel function, ε represents a threshold, and

$${W}_{ij}^{D}$$

represents an element of an i^{th} row and a j^{th} column of the geographical position matrix W^{D};
determining, by the neighbor relationship matrix W^{N}, whether the wind turbines are adjacent, and a specific expression is as follows:

$${W}_{ij}^{N} := \{ \begin{matrix}1 , & if an ith wind turbine and a jth wind turbine are adjacent , \\ 0 , & other conditions .\end{matrix}$$

$$where {W}_{ij}^{N}$$

represents an element of an i^{th} row and a j^{th} column of the neighbor relationship matrix W^{N}; and
representing, by the Euclidean distance matrix W^{E}, an approximate distribution of the power data through a histogram, and then fitting a trend of the histogram through a function ƒ(x)=αe^{-βx}, to obtain values of α and β of ƒ(x)=αe^{-βx} corresponding to each histogram, calculating a Euclidean distance

$${d}_{ij}^{E}$$

of each wind turbine by applying a Euclidean distance formula, and obtaining a Euclidean distance-mapped weight through the Gaussian kernel function, where a specific expression is as follows:

$${d}_{ij}^{E} = \sqrt{{( {α}_{i} - {α}_{j} )}^{2} + {( {β}_{i} - {β}_{j} )}^{2}}$$

$${W}_{ij}^{E} := \{ \begin{matrix}exp ( - \frac{{‖ {d}_{ij}^{E} ‖}^{2}}{{σ}_{E}^{2}} ) , & wherein i \neq j \\ 0 , & other conditions\end{matrix} .$$

where αᵢ, αⱼ, βᵢ, βⱼ respectively represent parameters of a fitting function ƒ(x)=αe^{-βx} corresponding to power histograms of the i^{th} wind turbine and the j^{th} wind turbine, σ_{E} represents a standard deviation parameter of the Gaussian kernel function, and

$${W}_{ij}^{E}$$

represents an element or an i^{th} row and a j^{th} column of the Euclidean distance matrix W^{E}.

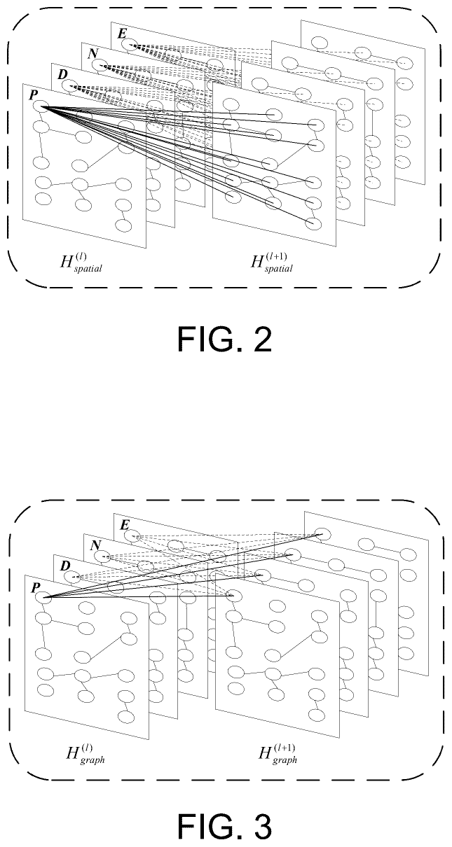

As shown in FIG. 2, four W matrices obtained in step S22 include matrices W^{P}, W^{D}, W^{N}, W^{E} that respectively represent four different information meanings and cover an important implicit relationship between the wind turbines.

In step S3, the performing spatial correlation embedding and inter-graph correlation embedding in the spatial graph embedding module includes the following steps.
S31: Combine the plurality of graph matrices into a multi-graph matrix block W^{M} in a stacking manner, where the distance relationship between the wind turbines reflects spatial correlation to a large extent, perform spatial embedding on the geographical position matrix W^{D}, capture, by using a Node2Vec model, a spatial structure relationship between wind turbine nodes by learning similarity between the nodes, and represent the node as a dense vector SE;
S32: Perform graph embedding on one node of each graph of W^{M}, and encode a selected node via OneHot, to obtain a vector assignment GE between graphs.
S33: Add SE and GE together, to obtain an embedding matrix W^{SGE} that includes spatial information and inter-graph information.

In step S3, the cross-fusion convolution module includes two convolution attention modules and a gated fusion unit, each of two convolution attention layers is connected with one fully connected layer, an activation function of the gated fusion unit is the sigmoid function, one fully connected layer is connected to the gated fusion unit, the fully connected layer is a ReLU function, and the two convolution attention modules are a channel attention module and a spatial attention module respectively. Specifically, the four graph information matrices that represent different meanings and that are obtained in step S32 enter the spatial graph embedding module, to perform spatial correlation embedding and inter-graph correlation embedding.

The performing attention extraction and fusion on the cross-fusion convolution module includes the following steps.
S34: Input the embedding matrix W^{SGE} obtained in step S33 to the two convolution attention modules.
S35: Perform dimension conversion on the embedding matrix W^{SGE}, such that the embedding matrix subjected to dimension conversion is appropriately put into the cross-fusion convolution module, to obtain a spatial embedding matrix

$${W}_{spatial}^{SGE}$$

and a graph embedding matrix

$${W}_{graph}^{SGE} ,$$

respectively input

$${W}_{spatial}^{SGE} and {W}_{graph}^{SGE}$$

to the cross-fusion convolution module, and sequentially enter the channel attention module and the spatial attention module in the cross-fusion convolution module,

$$\{ \begin{matrix}{M}_{CA} ( W ) & = sigmoid ( MLP ( AvgPool ( W ) ) + MLP ( MaxPool ( W ) ) ) \\ {M}_{SA} ( W ) & = sigmoid ( Conv ( [ AvgPool ( W ) ) ; MaxPool ( W ) ] ) )\end{matrix}$$

$$\{ \begin{matrix}{W}_{spatial}^{′} & = {M}_{CA} ( {W}_{spatial}^{SGE} ) ⊗ {W}_{spatial}^{SGE} \\ {W}_{spatial} & = {M}_{SA} ( {W}_{spatial}^{′} ) ⊗ {W}_{spatial}^{′} \\ {W}_{graph}^{′} & = {M}_{CA} ( {W}_{graph}^{SGE} ) ⊗ {W}_{graph}^{SGE} \\ {W}_{graph}^{″} & = {M}_{SA} ( {W}_{graph}^{′} ) ⊗ {W}_{graph}^{′}\end{matrix}$$

where W represents an input embedding matrix, AvgPool and MaxPool represent an average pooling operation and a maximum pooling operation respectively, MLP represents the two fully connected layers, Conv represents a 2D convolution layer, M_{CA} represents channel attention processing, M_{SA} represents spatial attention processing, ⊗ represents matrix multiplication,

$${W}_{spatial}^{′}$$

represents an intermediate result obtained by performing channel processing on

$${W}_{spatial}^{SGE} , {W}_{graph}^{′}$$

represents an intermediate result obtained by performing channel processing on

$${W}_{graph}^{SGE} , {W}_{spatial}^{″}$$

represents a spatial attention matrix, and

$${W}_{graph}^{″}$$

represents a graph attention matrix; and
S36: Input, to the gated fusion unit, a spatial attention matrix

$${W}_{spatial}^{″}$$

and a graph attention matrix

$${W}_{graph}^{″}$$

subjected to attention convolution processing, to obtain a multi-view topology matrix A_{SG},

$$\{ \begin{matrix}z & = σ ( F C ( {W}_{spatial}^{″} ) {W}_{1} + F C ( {W}_{graph}^{″} ) {W}_{2} + b ) \\ {A}_{SG} & = z ⊙ F C ( {W}_{spatial}^{″} ) + ( 1 - z ) ⊙ F C ( {W}_{graph}^{″} )\end{matrix}$$

where FC represents the fully connected layer, W₁, W₂, and b represent three parameters capable of being used for gradient training, z represents weight coefficients of the spatial attention matrix and the graph attention matrix, ⊙ represents a Hadamard product, and σ represents a sigmoid function.

The processing process of the attention convolution module is shown in FIG. 2. An l^{th} input

$${H}_{spatial}^{( l )} and {H}_{graph}^{( l )}$$

embedding matrix W^{SGE} across enter the attention convolution module, to output

$${H}_{spatial}^{( l + 1 )} and {H}_{graph}^{( l + 1 )} .$$

Taking a specific wind turbine as an example, from a spatial perspective, FIG. 2 shows that a spatial relationship between the wind turbine and another wind turbine in each graph matrix is implemented through spatial attention; and from a graph perspective, FIG. 3 shows that an inter-graph relationship between the wind turbines in each graph matrix is implemented through graph attention.

In step S4, domain information, of a feature sequence X=[X₁, X₂, . . . , Xₘ] of the m wind turbines, extracted between spatial nodes via a graph convolution kernel g_{θ}, and the multi-view topology matrix A_{SG} are input to the graph convolutional neural network, to extract domain information

$${X}^{′} = [ {X}_{1}^{′} , {X}_{2}^{′} , … , {X}_{m}^{′} ]$$

the spatial nodes through a graph convolution kernel function g_{θ}.

In step S4, calculation steps of a graph convolution formula in the graph convolutional neural network are as follows:
S41: Set a preliminary graph convolution formula of the graph convolutional neural network as follows:

$${g}_{θ} {*}_{G} x = {g}_{θ} ( L ) x = {g}_{θ} ( U Λ {U}^{T} ) x = {Ug}_{θ} ( Λ ) {U}^{T} x$$

where x represents input data, g_{θ} represents the graph convolution kernel function, *G represents a graph convolution operation, L=D−A_{SG} represents a Laplacian matrix of the graph, with a normalization form and a decomposition form of a feature value being

$$L = {I}_{N} - {D}^{- \frac{1}{2}} {A}_{𝒮 G} {D}^{- \frac{1}{2}} ∈ {R}^{N \times N} and L = U Λ {U}^{T} ∈ {R}^{N \times N}$$

respectively, Λ=diag(λ₀, . . . , λ_{N-1})∈R^{N×N} represents a diagonal matrix, U represents a feature vector obtained after normalization is performed on a Laplacian matrix L, A_{SG}∈R^{N×N} represents the multi-view topology matrix, I_{N}∈R^{N×N} represents a unit matrix, and a degree matrix D∈R^{N×N} is a diagonal matrix constituted with node degrees Dᵢᵢ=Σⱼ Aᵢⱼ;
S42: Approximately replace a spectral domain convolution kernel with a Chebyshev polynomia, where the Chebyshev polynomia is defined as:

$${g}_{θ} ( Λ ) = {\sum }_{k = 0}^{K - 1} {θ}_{k} {T}_{k} ( \tilde{Λ} )$$

where K represents a total quantity of terms of the Chebyshev polynomia, θₖ represents a coefficient vector of a k^{th} term of the Chebyshev polynomia, and a Chebyshev polynomia that is calculated recursively is defined as follows:

$${T}_{k} ( x ) = 2 {xT}_{k - 1} ( x ) - {T}_{k - 2} ( x )$$

where T₀(x)=1, T₁(x)=x, information of 0^{th} to (K−1)^{th} order neighbors around each node in the graph is extracted through approximate expansion of the Chebyshev polynomia, and because a definition domain of Tₖ(x)=cos(k·arccos(x)) is as [−1, 1], that is, a value domain of \tilde{Λ} is [−1, 1], the following is obtained after standardization of a feature vector matrix Λ:

$$\tilde{Λ} = \frac{2}{{λ}_{max}} Λ - {I}_{N}$$

where λₘₐₓ represents a maximum value of a feature value of the Laplacian matrix; and
S43 S43: Replace a convolution kernel with Tₖ(Λ̅), to obtain a final graph convolution formula as follows:

$$\begin{matrix}{g}_{θ} {*}_{G} x = {Ug}_{θ} ( Λ ) {U}^{T} x & = U ( {\sum }_{k = 0}^{K - 1} {θ}_{k} {T}_{k} ( \tilde{Λ} ) ) {U}^{T} x \\ & = {\sum }_{k = 0}^{K - 1} {θ}_{k} {T}_{k} ( U \tilde{Λ} {U}^{T} ) x \\ & = {\sum }_{k = 0}^{K - 1} {θ}_{k} {T}_{k} ( \tilde{L} ) x\end{matrix}$$

where \tilde{L}=U\tilde{Λ}U^{T}.

In step S5, the multi-timing gating module implements different receptive fields via different sizes of convolution kernels, and

$${X}^{′} = [ {X}_{1}^{′} , {X}_{2}^{′} , … , {X}_{m}^{′} ]$$

is input and processed via 1×S convolution kernels Γ∈R^{1×S×C×2C}, where S represents a size of the convolution kernel, C represents a quantity of channels, finally output power

$${Y}_{pred} = [ {Y}_{1}^{pred} , {Y}_{2}^{pred} , … , {Y}_{m}^{pred} ]$$

of each wind turbine is obtained, and a formula is as follows:

$$\{ \begin{matrix}{X}^{″} & = Γ * {X}^{′} ∈ {R}^{N \times ( M - ( S - 1 ) ) \times 2 C} \\ {Γ}_{i} {*}_{τ} {X}^{′} & = tanh ( {X}_{st}^{″} ) ⊙ sigmoid ( {X}_{rd}^{″} ) ∈ {R}^{N \times ( M - ( S - 1 ) ) \times 2 C}\end{matrix}$$

where *_{τ} represents a gated convolution operator,

$${X}_{st}^{″} and {X}_{rd}^{″}$$

respectively represent a first half and a second half of X″ with a doubled quantity of channels, Γᵢ represents an i^{th} convolution kernel; and a formula for calculating the output power of each wind turbine by superimposing GTU into M-GTU is specifically as follows:

$${y}_{pred} = ReLU ( Pooling ( Concat ( ( {Γ}_{1} {*}_{τ} {X}^{′} ) , ( {Γ}_{2} {*}_{τ} {X}^{′} ) , ( {Γ}_{3} {*}_{τ} {X}^{′} ) ) ) + {X}^{′} )$$

where Γ₁, Γ₂, and Γ₃ represent the different sizes of the convolution kernels, that is, 1×S₁, 1×S₂, and 1×S₃ respectively, Pooling represents a pooling layer, Concat represents a splicing operation, and X′ is obtained by splicing three different sizes of GTUs.

By performing the above steps, in the multi-view fusion method for forecasting power of wind turbine group in an offshore wind farm provided in the present invention, the structural features of the wind turbines can be fully captured, and the dynamic features of the wind turbine group can be fully captured. This effectively reduces an error caused by ignoring the relationship between the wind turbines, makes up for the lack of data features of a single wind turbine, and improves overall forecast accuracy of offshore wind power.

### Embodiment 2

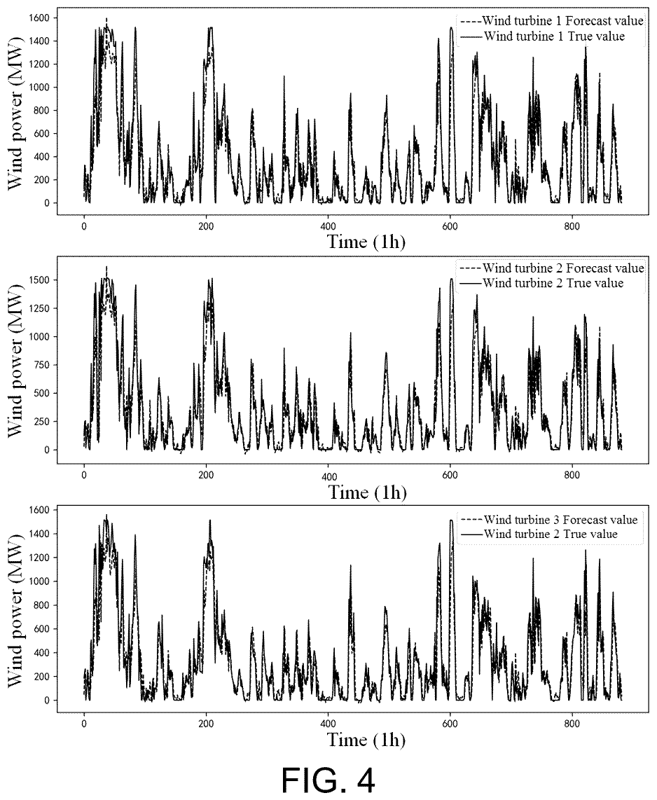

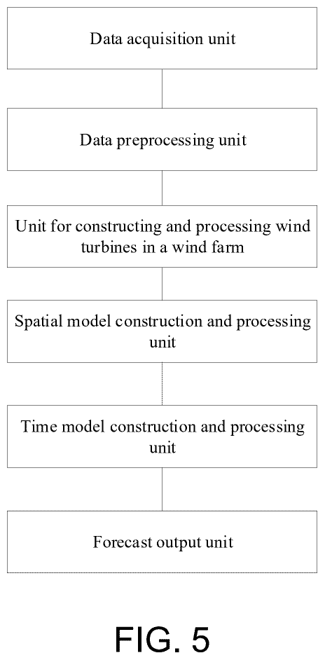

This embodiment is an application embodiment of the Embodiment 1. In this embodiment, in step S1, data related to the wind power, for example, power, wind speed, wind direction, and precipitation data of 134 wind turbines in an offshore wind farm from 00:00 on January 1, 2022 to 23:00 on July 29, 2022 is obtained. The multi-view topology matrix in this region is obtained by performing spatial graph embedding and cross-fusion convolution, a Chebyshev polynomia K in the graph convolution network is set to 3, sizes of three convolution kernels in the multi-timing gating are 1, 3, and 5 respectively, and a forecast effect diagram of the wind power as shown in FIG. 4 is obtained through the multi-view fusion method for forecasting power of wind turbine group in an offshore wind farm provided in the present invention. In FIG. 4, due to a large quantity of wind turbines, in this embodiment, forecast power results of the three wind turbines are used for verification. A solid line is an actual value of the wind power, that is, the actual value of the wind power is taken as a forecast target of the wind power, and three dotted lines are forecast output values of the wind power. It can be seen that the forecast output value of the wind power is very close to the actual value of the wind power, fitting effect is good, and forecast accuracy is high. It can be learned that better forecast effect of the wind power can be obtained in the present application.

### Embodiment 3

This embodiment provides a multi-view fusion system for forecasting power of wind turbine group in an offshore wind farm. The system includes: .
a data acquisition unit configured to obtain power, a wind speed, a wind direction, and precipitation data of wind turbines in a target offshore wind farm, and a geographical position of each wind turbine, specifically, configured to acquire original data of a wind farm, extract a wind speed time sequence, a wind direction time sequence, and a wind power time sequence from the original data of the wind farm, and obtain original geographical positions of the wind turbines in the wind farm;
a data preprocessing unit configured to perform preprocessing on the data acquired by the data acquisition unit, to obtain a feature matrix and a graph matrix, the graph matrix including a power relationship matrix, a geographical position matrix, a neighbor relationship matrix, and a Euclidean distance matrix; and specifically, configured to perform preprocessing on a time sequence extracted from the original data of the wind farm, to obtain a feature vector, take the wind power time sequence as a forecast target value, and uniformly divide the feature vector and the wind power time sequence into a training set and a validation set;
a unit for constructing and processing graph for wind turbine group in a wind farm is configured to: construct a spatial graph embedding module and a cross-fusion convolution module, the spatial graph embedding module being configured to perform spatial correlation embedding and inter-graph correlation embedding, and the cross-fusion convolution module being configured to perform attention extraction and fusion, to obtain a feature matrix that fuses a plurality of pieces of topological information, wherein the data information of each wind turbine is regarded as a node and based on data correlation, geographic information, and data distribution of the wind turbine, a plurality of relationship networks between the wind turbines, which include a coupling relationship between the wind turbines m, are formed;
a spatial model construction and processing unit is configured to: construct a Chebyshev graph convolutional neural network that uses graph information features, and input a multi-view graph matrix and preprocessed data to the graph convolutional neural network, to enable the data feature of a single wind turbine to be fully integrated with effective information of other wind turbines at a plurality of viewing angle.

The time model construction and processing unit is configured to: construct a multi-timing gating neural network that uses time feature, to extract a time continuity feature of the wind turbine.

The forecast output unit is configured to input the multi-view graph matrix and a feature vector of the test set to a trained neural network, to obtain a forecast output of the wind power of the wind turbines.

Through the multi-view fusion system for forecasting power of wind turbine group in an offshore wind farm in this embodiment, the data preprocessing unit performs preprocessing on the wind speed time sequence, the wind direction time sequence, and the wind power time sequence, to obtain the feature vector, and constructs the power relationship matrix, the geographical position matrix, the neighbor relationship matrix, and the Euclidean distance matrix based on the data and the geographical positions of the wind turbines, and the unit for constructing and processing graph for wind turbine group in a wind farm embed the graph matrix into node spatial information and inter-graph node information, and inputs the embedding information matrix to the cross-fusion convolution module, to further concern and extract key spatial information and key inter-graph information, to obtain the multi-view topology matrix, thereby providing an effective weight relationship between the wind turbines for the subsequent graph convolutional neural network. The spatial model construction and processing unit constructs the Chebyshev graph convolutional neural network to process the feature vector and the multi-view topology matrix, to enable the feature vector of each wind turbine to obtain effective weights of other wind turbines. The time model construction and processing unit constructs the multi-timing gating module to screen a timing feature. Finally the forecast output unit forecasts and outputs the wind power of the wind turbines. In the multi-view fusion method for forecasting power of wind turbine group in an offshore wind farm provided in the present invention, the structural features of the wind turbine group can be fully captured, and the dynamic features of the wind turbine group can be fully captured. This effectively reduces an error caused by ignoring the relationship between the wind turbines, makes up for the lack of data features of a single wind turbine, and improves overall forecast accuracy of offshore wind power.

The specific content of the above implementations can be employed in arbitrary and contradictory combinations. To provide a concise description of these implementations, all possible combinations of all the technical features may not be described; however, these combinations of the technical features should be construed as falling within the scope defined by the specification as long as no contradiction occurs.

It is apparent that the above embodiments are merely intended to describe the present invention clearly, rather than to limit the implementations of the present invention. The person of ordinary skill in the art may make modifications or variations in other forms based on the above description. There are no need and no way to exhaust all the implementations. Any modification, equivalent substitution and improvement made within the spirit and principle of the present invention should fall within the protection scope of the claims of the present invention.

1. A multi-view fusion method for forecasting power of wind turbine group in an offshore wind farm, comprising the following steps:
S1, obtaining power, a wind speed, a wind direction, and precipitation data of each wind turbine in a target offshore wind farm, and a geographical position of each wind turbine, and performing preprocessing the power, the wind speed, the wind direction, and the precipitation data of each wind turbine in the target offshore wind farm, and the geographical position of each wind turbine which are obtained;
S2, constructing a feature matrix with preprocessed power, wind speed, wind direction, and precipitation data in the wind farm, and constructing a plurality of information matrices based on the preprocessed power of each wind turbine in the wind farm and the geographical position of each wind turbine;
S3, constructing a spatial graph embedding module and a cross-fusion convolution module, sequentially inputting a plurality of graph matrices to the spatial graph embedding module and the cross-fusion convolution module, performing spatial correlation embedding and inter-graph correlation embedding in the spatial graph embedding module, and performing attention extraction and fusion on the cross-fusion convolution module, wherein the graph matrix comprises a power relationship matrix, a geographical position matrix, a neighbor relationship matrix, and a Euclidean distance matrix;
S4, constructing a graph convolutional neural network that considers influence of spatial topology, and inputting a processed feature matrix together with a multi-view topology matrix to the graph convolutional neural network, to obtain a feature matrix that fuses a plurality of pieces of topological information;
S5, constructing a multi-timing gating module, making the feature matrix that fuses the information pass through the multi-timing gating module to implement receptive fields at different times via the feature matrix that fuses the information, and finally obtaining a forecast output of spatiotemporal information aggregation; and
S6, training a model with a training set, to obtain an optimal model parameter, and inputting a wind power state feature at a next time point to an optimal model obtained through training, to forecast wind power at the next time point.

2. The multi-view fusion method for forecasting power of wind turbine group in an offshore wind farm according to claim 1, wherein in step S1, min-max normalization processing is performed on a power sequence, a wind speed sequence, and a precipitation sequence, to obtain a power sequence P, a wind speed sequence WS, and a precipitation sequence PRECIP after the normalization processing, and sine and cosine processing is performed on a wind direction sequence, to obtain a sine of wind direction SWD and a cosine of wind direction CWD.

3. The multi-view fusion method for forecasting power of wind turbine group in an offshore wind farm according to claim 1, wherein in step S2, the information matrix comprises a power relationship matrix W^{P}, a geographical position matrix W^{D}, a neighbor relationship matrix W^{N}, and a Euclidean distance matrix W^{E}.

4. The multi-view fusion method for forecasting power of wind turbine group in an offshore wind farm according to claim 3, wherein step S2 comprises the following steps:
S21, performing preprocessing to obtain a feature matrix X of m wind turbines, wherein X=[X₁, X₂, . . . , Xₘ], Xₘ represents a matrix constructed with features of an m^{th} wind turbine from a time point t−1 to a time point t−n, and Xₘ is expressed as follows:
$${X}_{m} = [ \begin{matrix}{P}_{m}^{t - 1} & {WS}_{m}^{t - 1} & {SWD}_{m}^{t - 1} & {CWD}_{m}^{t - 1} & {PRECIP}_{m}^{t - 1} \\ {P}_{m}^{t - 2} & {WS}_{m}^{t - 2} & {SWD}_{m}^{t - 2} & {CWD}_{m}^{t - 2} & {PRECIP}_{m}^{t - 2} \\ … & … & … & … & … \\ {P}_{m}^{t - n} & {WS}_{m}^{t - n} & {SWD}_{m}^{t - n} & {CWD}_{m}^{t - n} & {PRECIP}_{m}^{t - n}\end{matrix} ]$$
$$wherein {P}_{m}^{t - n} , {WS}_{m}^{t - n} , {SWD}_{m}^{t - n} , {CWD}_{m}^{t - n} , and {PRECIP}_{m}^{t - n}$$
respectively represent power, a wind speed, a wind direction sine, a wind direction cosine, and a precipitation of the m^{th} wind farm at the time point t−n;
S22, constructing the plurality of information matrices based on different perspectives, comprising:
calculating, by the power relationship matrix W^{P}, a Pearson correlation coefficient between power data of the wind turbines, to obtain a correlation coefficient Rᵢⱼ between every two wind turbines, and mapping the correlation coefficient Rᵢⱼ into an interval of [−1, 1] through a sigmoid function, wherein a specific expression is as follows:
$$R = \frac{{\sum }_{k = 1}^{n} ( {a}_{k} - \overline{a} ) ( {b}_{k} - \overline{b} )}{\sqrt{{\sum }_{k = 1}^{n} {( {a}_{k} - \overline{a} )}^{2} {\sum }_{k = 1}^{n} {( {b}_{k} - \overline{b} )}^{2}}}$$
$${W}_{ij}^{P} := \{ \begin{matrix}sigmoid ( {R}_{ij} ) , & wherein i \neq j , \\ 1 , & other conditions .\end{matrix}$$
wherein R represents the Pearson correlation coefficient, n represents a dimension of a variable, a and b respectively represent power of two wind turbines, aₖ and bₖ respectively represent k^{th} data points of the power of the two wind turbines, ā and b̅ respectively represent mean values of the power of the two wind turbines, k∈[1, n],
$${W}_{ij}^{P}$$
represents an element of an i^{th} row and a j^{th} column of the power relationship matrix W^{P}, and Rᵢⱼ represents a Pearson correlation coefficient between an i^{th} wind turbine and a j^{th} wind turbine;
calculating, by the geographical position matrix W^{D}, a distance dᵢⱼ between the wind turbines based on a collected coordinate position of each wind turbine, and obtaining a distance-mapped weight through a Gaussian kernel function, wherein a specific expression is as follows:
$${W}_{ij}^{D} := \{ \begin{matrix}exp ( - \frac{{d}_{ij}^{2}}{{σ}_{D}^{2}} ) , & wherein i \neq j and exp ( - \frac{{d}_{ij}^{2}}{{σ}_{D}^{2}} ) \geq ε , \\ 0 , & other conditions .\end{matrix}$$
wherein σ_{D} represents a standard deviation parameter of the Gaussian kernel function, ε represents a threshold, and
$${W}_{ij}^{D}$$
represents an element of an i^{th} row and a j^{th} column of the geographical position matrix W^{D};
determining, by the neighbor relationship matrix W^{N}, whether the wind turbines are adjacent, and a specific expression is as follows:
$${W}_{ij}^{N} : = \{ \begin{matrix}1 , & if an ith wind turbine and a jth wind turbine are adjacent , \\ 0 , & other conditions .\end{matrix}$$
$$wherein {W}_{ij}^{N}$$
represents an element of an i^{th} row and a j^{th} column of the neighbor relationship matrix W^{N}; and
representing, by the Euclidean distance matrix W^{E}, an approximate distribution of the power data through a histogram, and then fitting a trend of the histogram through a function ƒ(x)=αe^{-βx}, to obtain values of α and β of ƒ(x)=αe^{-βx} corresponding to each histogram, calculating a Euclidean distance
$${d}_{ij}^{E}$$
of each wind turbine by applying a Euclidean distance formula, and obtaining a Euclidean distance-mapped weight through the Gaussian kernel function, wherein a specific expression is as follows:
$${d}_{ij}^{E} = \sqrt{{( {α}_{i} - {α}_{j} )}^{2} + {( {β}_{i} - {β}_{j} )}^{2}}$$
$${W}_{ij}^{E} := \{ \begin{matrix}exp ( - \frac{{‖ {d}_{ij}^{E} ‖}^{2}}{{σ}_{E}^{2}} ) , & wherein i \neq j \\ 0 , & other conditions .\end{matrix}$$
wherein αᵢ, αⱼ, βᵢ, βⱼ respectively represent parameters of a fitting function ƒ(x)=αe^{-βx} corresponding to power histograms of the i^{th} wind turbine and the j^{th} wind turbine, σ_{E} represents a standard deviation parameter of the Gaussian kernel function, and
$${W}_{ij}^{E}$$
represents an element of an i^{th} row and a j^{th} column of the Euclidean distance matrix W^{E}.

5. The multi-view fusion method for forecasting power of wind turbine group in an offshore wind farm according to claim 4, wherein in step S3, the performing spatial correlation embedding and inter-graph correlation embedding in the spatial graph embedding module comprises the following steps:
S31, combining the plurality of graph matrices into a multi-graph matrix block W\hat{ }E in a stacking manner, performing spatial embedding on the geographical position matrix W\hat{ }D, capturing, by using a Node2Vec model, a spatial structure relationship between wind turbine nodes by learning similarity between the nodes, and representing the node as a dense vector SE;
S32, performing graph embedding on one node of each graph of W\hat{ }M, and encoding a selected node via OneHot, to obtain a vector assignment GE between graphs; and
S33, adding SE and GE together, to obtain an embedding matrix W\hat{ }SGE that comprises spatial information and inter-graph information.

6. The multi-view fusion method for forecasting power of wind turbine group in an offshore wind farm according to claim 5, wherein in step S3, the cross-fusion convolution module comprises two convolution attention modules and a gated fusion unit, each of two convolution attention layers is connected with one fully connected layer, an activation function of the gated fusion unit is the sigmoid function, one fully connected layer is connected to the gated fusion unit, an activation function of the fully connected layer is a ReLU function, and the two convolution attention modules are a channel attention module and a spatial attention module respectively.

7. The multi-view fusion method for forecasting power of wind turbine group in an offshore wind farm according to claim 6, wherein the performing attention extraction and fusion on the cross-fusion convolution module comprises the following steps:
S34, inputting the embedding matrix W^{SGE} obtained in step S33 to the two convolution attention modules;
S35, performing dimension conversion on the embedding matrix W^{SGE} such that the embedding matrix subjected to dimension conversion is appropriately put into the cross-fusion convolution, to obtain a spatial embedding matrix
$${W}_{spatial}^{SGE}$$
and a graph embedding matrix
$${W}_{graph}^{SGE} ,$$
respectively inputting the spatial embedding matrix
$${W}_{spatial}^{SGE}$$
and the spatial embedding matrix
$${W}_{graph}^{SGE}$$
to the cross-fusion convolution, and sequentially entering the channel attention module and the spatial attention module in the cross-fusion convolution,
$$\{ \begin{matrix}{M}_{CA} ( W ) = sigmoid ( MLP ( AvgPool ( W ) ) + MLP ( MaxPool ( W ) ) ) \\ {M}_{SA} ( W ) = sigmoid ( Conv ( [ AvgPool ( W ) ; MaxPool ( W ) ] ) )\end{matrix}$$
$$\{ \begin{matrix}{W}_{spatial}^{′} = {M}_{CA} ( {W}_{spatial}^{SGE} ) ⊗ {W}_{spatial}^{SGE} \\ {W}_{spatial}^{″} = {M}_{SA} ( {W}_{spatial}^{′} ) ⊗ {W}_{spatial}^{′} \\ {W}_{graph}^{′} = {M}_{CA} ( {W}_{graph}^{SGE} ) ⊗ {W}_{graph}^{SGE} \\ ( {W}_{graph}^{″} = {M}_{SA} ( {W}_{graph}^{′} ) ⊗ {W}_{graph}^{′}\end{matrix}$$
wherein W represents an input embedding matrix, AvgPool and MaxPool represent an average pooling operation and a maximum pooling operation respectively, MLP represents the two fully connected layers, Conv represents a 2D convolution layer, M_{CA} represents channel attention processing, M_{SA} represents spatial attention processing, ⊗ represents matrix multiplication,
$${W}_{spatial}^{′}$$
represents an intermediate result obtained by performing channel processing on
$${W}_{spatial}^{S G E} , {W}_{graph}^{′}$$
represents an intermediate result obtained by performing channel processing on
$${W}_{graph}^{SGE} , {W}_{spatial}^{″}$$
represents a spatial attention matrix, and
$${W}_{gτaph}^{″}$$
represents a graph attention matrix; and
S36, inputting, to the gated fusion unit, a spatial attention matrix
$${W}_{spatial}^{″}$$
and a graph attention matrix
$${W}_{gτaph}^{″}$$
subjected to attention convolution processing, to obtain a multi-view topology matrix A_{SG},
$$\{ \begin{matrix}z = σ ( FC ( {W}_{spatial}^{″} ) {W}_{1} + FC ( {W}_{graph}^{″} ) {W}_{2} + b ) \\ {A}_{SG} = z ⊙ FC ( {W}_{spatial}^{″} ) + ( 1 - z ) ⊙ ( {W}_{graph}^{″} )\end{matrix}$$
wherein FC represents the fully connected layer, W₁, W₂, and b represent three parameters capable of being used for gradient training, z represents weight coefficients of the spatial attention matrix and the graph attention matrix, ⊙ represents a Hadamard product, and σ represents a sigmoid function.

8. The multi-view fusion method for forecasting power of wind turbine group in an offshore wind farm according to claim 7, wherein in step S4, domain information, of a feature sequence X=[X₁, X₂, . . . , Xₘ] of the m wind turbines, extracted between spatial nodes via a graph convolution kernel g_{θ}, and the multi-view topology matrix A_{SG} are input to the graph convolutional neural network, to extract domain information X′=[X′₁, X′₂, . . . , X′ₘ] between the spatial nodes through a graph convolution kernel function g_{θ}.

9. The multi-view fusion method for forecasting power of wind turbine group in an offshore wind farm according to claim 8, wherein in step S4, calculation steps of a graph convolution formula in the graph convolutional neural network are as follows:
S41, setting a preliminary graph convolution formula of the graph convolutional neural network as follows:
$$g θ {*}_{G} x = {g}_{θ} ( L ) x = {g}_{θ} ( {U Λ U}^{T} ) x = {U g}_{θ} ( Λ ) {U}^{T} x$$
wherein x represents input data, g_{θ} represents the graph convolution kernel function, *G represents a graph convolution operation, L=D−A_{SG} represents a Laplacian matrix of the graph, with a normalization form and a decomposition form of a feature value being
$$L = {I}_{N} - {D}^{- \frac{1}{2}} {A}_{𝒮G} {D}^{- \frac{1}{2}} ∈ {R}^{N \times N} and$$
$$L = {U Λ U}^{T} ∈ {R}^{N \times N}$$
respectively, Λ=diag(λ₀, . . . , λ_{N-1})∈R^{N×N} represents a diagonal matrix, U represents a feature vector obtained after normalization is performed on a Laplacian matrix L, A_{SG}␣R^{N×N} represents the multi-view topology matrix, I_{N}∈R^{N×N} represents a unit matrix, and a degree matrix D∈R^{N×N} is a diagonal matrix constituted with node degrees Dᵢᵢ=Σⱼ Aᵢⱼ;
S42, approximately replacing a spectral domain convolution kernel with a Chebyshev polynomia, wherein the Chebyshev polynomia is defined as:
$${g}_{θ} ( Λ ) = {\sum }_{k = 0}^{K - 1} {θ}_{k} {T}_{k} ( \tilde{Λ} )$$
wherein K represents a total quantity of terms of the Chebyshev polynomia, θₖ represents a coefficient vector of a k^{th} term of the Chebyshev polynomia, and a Chebyshev polynomia that is calculated recursively is defined as follows:
$${T}_{k} ( x ) = 2 x {T}_{k - 1} ( x ) - {T}_{k - 2} ( x )$$
wherein T₀(x)=1, T₁(x)=x, information of 0^{th} to (K−1)^{th} order neighbors around each node in the graph is extracted through approximate expansion of the Chebyshev polynomia, and because a definition domain of Tₖ(x)=cos(k·arccos(x)) is as [−1, 1], that is, a value domain of \tilde{Λ} is [−1, 1], the following is obtained after standardization of a feature vector matrix Λ:
$$\tilde{Λ} = \frac{2}{{λ}_{max}} Λ - {I}_{N}$$
wherein λₘₐₓ represents a maximum value of a feature value of the Laplacian matrix; and
S43, replacing a convolution kernel with T₁(\tilde{Λ}), to obtain a final graph convolution formula as follows:
$$\begin{matrix}{g}_{θ} {*}_{G} x = {Ug}_{θ} ( Λ ) {U}^{T} x = U ( {\sum }_{k = 0}^{K - 1} {θ}_{k} {T}_{k} ( \tilde{Λ} ) ) {U}^{T} x \\ = {\sum }_{k = 0}^{K - 1} {θ}_{k} {T}_{k} ( U \tilde{Λ} {U}^{T} ) x \\ = {\sum }_{k = 0}^{K - 1} {θ}_{k} {T}_{k} ( \tilde{L} ) x\end{matrix}$$
wherein \tilde{L}=U\tilde{Λ}U^{T}.

10. The multi-view fusion method for forecasting power of wind turbine group in an offshore wind farm according to claim 9, wherein in step S5, the multi-timing gating module implements different receptive fields via different sizes of convolution kernels, and
$${X}^{′} = [ {X}_{1}^{′} , {X}_{2}^{′} , … , {X}_{m}^{′} ]$$
is input and processed via 1×S convolution kernels Γ∈R^{1×S×C×2C}, wherein S represents a size of the convolution kernel, C represents a quantity of channels, finally output power
$${Y}_{pred} = [ {Y}_{1}^{pred} , {Y}_{2}^{pred} , … , {Y}_{m}^{pred} ]$$
of each wind turbine is obtained, and a formula is as follows:
$$\{ \begin{matrix}{X}^{″} = Γ * {X}^{′} ∈ {R}^{N \times ( M - ( S - 1 ) ) \times 2 C} \\ Γ , * , {X}^{′} = tanh ( {X}_{st}^{″} ) ⊙ sigmoid ( {X}_{rd}^{″} ) ∈ {R}^{N \times ( M - ( S - 1 ) ) \times 2 C}\end{matrix}$$
wherein *_{τ} represents a gated convolution operator,
$${X}_{st}^{″} and {X}_{rd}^{″}$$
respectively represent a first half and a second half of X″ having a doubled quantity of channels, Γᵢ represents an i^{th} convolution kernel; and a formula for calculating the output power of each wind turbine by superimposing GTU into M-GTU is specifically as follows:
$${Y}_{pred} = ReLU ( Pooling ( Concat ( ( {Γ}_{1} {*}_{τ} {X}^{′} ) , ( {Γ}_{2} {*}_{τ} {X}^{′} ) , ( {Γ}_{3} {*}_{τ} {X}^{′} ) ) ) + {X}^{′} )$$
wherein Γ₁, Γ₂, and Γ₃ represent the different sizes of the convolution kernels, that is, 1×S₁, 1×S₂, and 1×S₃ respectively, Pooling represents a pooling layer, Concat represents a splicing operation, and X′ is obtained by splicing three different sizes of GTUs.
